(19) United States
(12) Patent Application Publication
(10) Pub. No.: US 2010/0331225 A1
(43) Pub. Date: Dec. 30, 2010

(54) Multiple Use Fabric Conditioning Composition with Aminosilicone

(76) Inventors: Rajan Keshav Panandiker, West Chester, OH (US); Robert Richard Dykstra, Cleves, OH (US); Nicholas David Vetter, North Bend, OH (US); Julie Ann O'neil, Dillsboro, IN (US); Denise Malcuit Belanger, West Chester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/827,798

(22) Filed: Jun. 30, 2010

Related U.S. Application Data
(60) Provisional application No. 61/221,651, filed on Jun. 30, 2009.

(51) Int. Cl. C11D 7/60

(52) U.S. Cl. 510/107; 510/516; 510/101

(57) ABSTRACT

Multiple use fabric conditioning compositions comprising aminosilicones are disclosed. The disclosed compositions are capable of delivering a benefit to a fabric over multiple cycles. Such benefits may include removal of wrinkles, prevention of wrinkles, fabric softness, improved fabric feel, garment shape retention, garment shape recovery, elasticity, ease-of-ironing, perfume benefits, anti-pilling, or combinations thereof.

### CROSS REFERENCE TO RELATED APPLICATIONS

This application claims benefit of and priority to U.S. Provisional Application Ser. No. 61/221,651 filed Jun. 30, 2009.

### FIELD OF THE INVENTION

Multiple-use fabric conditioning compositions containing aminosilicones and methods of using said compositions are disclosed.

### BACKGROUND OF THE INVENTION

In some aspects, dryer-added fabric conditioning products may provide a better convenience to the consumer as compared to the rinse-added-type fabric conditioning products, as such products spare the consumer the requirement of having to be present right at the beginning of the rinse cycle. There are two main types of dryer-added fabric conditioning products: single use products and multiple-use products. Single use products, most commonly in the sheet form coated with a fabric conditioning active composition, call for adding a single sheet into an automatic clothes dryer containing a wet laundry load, at the beginning of the drying cycle. (See, e.g., U.S. Pat. Nos. 3,442,692 and 3,686,025. In contrast, multiple-use fabric conditioning products are placed in the interior of the dryer to release the fabric conditioning active to successive laundry loads. Each multiple-use product may last from a few cycles to about 50 or more cycles, and thus can be more convenient to the consumer than single use products. (See, e.g., in U.S. Pat. Nos. 3,967,008; 4,004,685 and 4,149,977). Another type of multiple-use product has the conditioning active exposed to be transferred to the fabric rather than covered by a permeable. Such products can be attached to the interior of the dryer. See, e.g., U.S. Pat. Nos. 3,696,034; 3,676,199 and USPA Nos. 2003/0192197 A1; and 2003/0195130 A1.

While the products disclosed in the art are known to provide a softening benefit, such benefit may not be at the level desired by the consumer. Further, there remains a need for fabric care agents that may be delivered via this method, but which impart benefits beyond softening, for example, abrasion resistance, wrinkle removal, pill prevention, anti-shrinkage, anti-static, anti-crease, fabric softness, fabric shape retention, and/or improved hand feel or texture. In particular, there remains a need for improved anti-wrinkle benefit compositions that can be provided in a format that is convenient to consumer.

### SUMMARY OF THE INVENTION

Multiple-use fabric conditioning compositions containing aminosilicones and methods of using said compositions are disclosed.

In one embodiment, the present disclosure provides a multi-use fabric conditioning composition comprising: (a) from about 0.1% to about 10% based on total multi-use fabric conditioning composition, of an aminosilicone having the structure of Formula I

[R₁R₂R₃SiO_{1/2}]ₙ[(R₄Si(X—Z)O_{2/2}]ₖ[R₄R₄SiO_{2/2}]ₘ[R₄SiO_{3/2}]ⱼ (Formula I)

wherein R₁, R₂, R₃ and R₄ are each independently selected from H, C₁-C₂₀ alkyl, C₁-C₂₀ substituted alkyl, C₆-C₂₀ aryl, C₆-C₂₀ substituted aryl, alkylaryl, C₁-C₂₀ alkoxy and combinations thereof; X is a divalent alkylene radical comprising 2-12 carbon atoms, or is independently selected from the group consisting of —(CH₂)s—; —CH₂—CH(OH)—CH₂—;

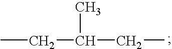

and mixtures thereof; wherein s is on average from about 2 to about 10; Z is selected from the group consisting of

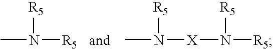

wherein R₅ is selected from H, C₁-C₂₀ alkyl, C₁-C₂₀ substituted alkyl, and combinations thereof; k is on average from about 3 to about 20; m is on average from about 100 to about 2,000; n is on average from about 2 to about 10;j is on average from about 0 to about 10; and
(b) a fabric softening active,
(c) a carrier component;
(d) an optional perfume component selected from the group consisting of
   (1) a perfume microcapsule, comprising a perfume carrier and an encapsulated perfume composition, wherein said perfume carrier is selected from the group consisting of cyclodextrins, starch microcapsules, porous carrier microcapsule, and combinations thereof; and wherein said encapsulated perfume composition comprises low volatile perfume ingredients, high volatile perfume ingredients, and mixtures thereof;
   (2) a pro-perfume;
   (3) a low odor detection threshold perfume ingredients, wherein said low odor detection threshold perfume ingredients comprise less than about 25%, by weight of the total neat perfume composition; and
   (4) mixtures thereof; and
(e) an optional ingredient selected from the group consisting of soil release agent, chelant, dye transfer inhibitor, dye fixative agent, chlorine scavenging agent, optical brightener, odor control agent, antimicrobial agent, fungicide, wrinkle control agent, anti-oxidant, preservative, insect repellent, moth repellent, processing agent, mold release agent, and mixtures thereof;
   wherein the weight ratio of said fabric softening active to said carrier component is from about 1:19 to about 19:1, and wherein said fabric conditioning composition exhibits a melting point greater than about 90° C.

According to another embodiment, the present disclosure provides a method of softening a fabric comprising the step of contacting said fabric with a composition according to the various embodiments described herein.

### DETAILED DESCRIPTION OF THE INVENTION

### Definitions

As used herein, articles such as “a” and “an” when used in a claim, are understood to mean one or more of what is claimed or described.

As used herein, the terms “include”, “includes” and “including” are meant to be non-limiting.

As used herein, an “effective amount” of a material or composition means the amount needed to accomplish an intended purpose, for example, to impart a desired level of fabric care benefit to a substrate.

As used herein, the term “pro-perfume” is herein defined to include: pro-fragrances, pro-perfumes, pro-accords, and mixtures thereof. The term “pro-perfume” is herein defined to include: pro-fragrances, pro-perfumes, pro-accords, and mixtures thereof. The term “multiple use” means that the multiple use fabric conditioning compositions as disclosed herein can be used to deliver a desired amount of fabric conditioning active to laundry during at least two cycles, at least about 10 cycles, at least about 20 cycles, at least about 30 cycles, at least about 40 cycles, or at least about 50 cycles, up to about 100, or about 200, or about 300, or about 400 cycles, before the fabric conditioning composition needs to be replaced. It should be understood that the term “laundry” refers to any textile or fabric material that is laundered.

As used herein, articles such as “a” and “an” when used in a claim, are understood to mean one or more of what is claimed or described.

As used herein, the term “solid” includes granular, powder, bar and tablet product forms.

As used herein, the term “fluid” includes liquid, gel, paste and gas product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### COMPOSITIONS

Multiple-use compositions, such as fabric conditioning composition, comprising an aminosilicone, a fabric softening active, a carrier component, an optional perfume component, and optional adjuncts are disclosed. Without being bound by theory, the aminosilicone of the disclosed compositions may provide improved benefits to the treated fabric, including improved softness, freshness, anti-wrinkle, or combinations thereof.

Such compositions may comprise from about 0.1% to about 10%, from about 0.5% to about 6% or from about 1% to about 3% by weight of an aminosilicone having the structure of Formula I below.

[R₁R₂R₃SiO_{1/2}]ₙ[(R₄Si(X—Z)O_{2/2}]ₖ[R₄R₄SiO_{2/2}]ₘ[R₄SiO_{3/2}]ⱼ (Formula I)

wherein
i) R₁, R₂, R₃ and R₄ may each be independently selected from H, C₁-C₂₀ alkyl, C₁-C₂₀ substituted alkyl, C₆-C₂₀ aryl, C₆-C₂₀ substituted aryl, alkylaryl, C₁-C₂₀ alkoxy and combinations thereof;
ii) X may comprise a divalent alkylene radical comprising 2-12 carbon atoms, or independently selected from the group consisting of —(CH₂)s—; —CH₂—CH(OH)—CH₂—;

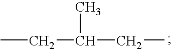

and mixtures thereof, wherein s may on average be from about 2 to about 10;
iii) Z may be selected from the group consisting of

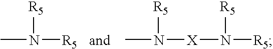

wherein R₅ may be selected from the group consisting of H, C₁-C₂₀ alkyl, C₁-C₂₀ substituted alkyl, and combinations thereof;
iv) k may be on average from about 3 to about 20, or from about 5 to about 18; or from about 5 to about 10;
v) m may be on average from about 100 to about 2,000, or from about 150 to about 1,000;
vi) n may be on average from about 2 to about 10, or about 2 to about 4, or 2; and
vii) j may be on average from about 0 to about 10, or about 0 to about 4, or 0.

In one aspect,
i) R₁ may each be independently selected from H, OH, methyl, C₁-C₂₀ alkoxy, and combinations thereof;
ii) R₂, R₃ and R₄ may be methyl groups;
iii) Z may be selected from

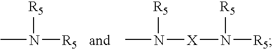

wherein R₅ may be selected from the group consisting of H, C₁-C₂₀ alkyl, and combinations thereof;
iv) X may be independently selected from the group consisting of —(CH₂)s—; —CH₂—CH(OH)—CH₂—;

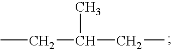

and mixtures thereof, wherein s may be on average from about 2 to about 6;
v) k may be on average from about 3 to about 20, or from about 5 to about 18, or from about 5 to about 10;
vi) m may be on average from about 150 to about 1,000;
vii) n may be on average from about 2 to about 6, or 2; such that n=j+2; and
viii) j may be from about 0 to about 4, alternatively 0.

As used herein, the nomenclature SiO_{“n”/2} represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

In another aspect, the aminosilicone may have an amine equivalent of from about 500 g/mol to about 4000 g/mol, or from about 1000 g/mol to about 3000 g/mol.

### Fabric Softening Active

The multiple use fabric conditioning compositions may comprise a fabric softening active and a carrier component. Suitable fabric softening actives include fabric softening ingredients that are commonly used in the fabric care compositions to provide fabric softening properties. Without being bound by theory, the carrier component mixes with the fabric softening active and helps the fabric softening active resist transfer to laundry by melting during the drying operation.

The carrier component may generally be chosen so that the fabric conditioning composition exhibits a melting point or softening point that may be above the operating temperature of the dryer. In most dryer operations, this means that the melting temperature of the fabric conditioning composition is above about 90° C. The melting temperature or the softening temperature of the fabric conditioning composition can be above about 95° C., above about 100° C., above about 110° C., or above about 120° C. The melting temperature of the fabric conditioning composition can be below 200° C.

The melting temperature of the fabric conditioning composition refers to the temperature at which the composition begins to flow under its own weight. As the fabric conditioning composition reaches its melting point, one will observe the composition undergoing a transfer from a solid discreet mass to a flowable liquid. Although a differential scanning calorimeter (DSC) measurement of the composition may reveal that certain portions or phases of the composition may exhibit melting at temperatures that are within the operating temperatures of a dryer, it should be understood that what is meant by the melting temperature of the composition is not the melting temperature of certain portions or phases within the composition, but the melting temperature of the composition as demonstrated by the composition being visibly observed as a flowable liquid. In general, the fabric conditioning composition may be provided as a solid mixture including multiple phases or as a solid solution including a single phase.

The softening temperature of the composition refers to the temperature at which the solid mass becomes easily deformable. For many exemplary compositions it may be expected that the softening temperature will be a few degrees below the melting temperature.

The fabric softening active can include any fabric conditioning active, that when melt mixed with the carrier component, provides a fabric conditioning composition exhibiting a desired melting temperature of greater than about 90° C., and that provides fabric softening properties to laundry as a result of its presence in the fabric conditioning composition when used during the operation of drying wet laundry in a dryer. Exemplary components that can be used as the fabric softening active include those fabric softening actives that are commonly used in the laundry drying process to provide fabric softening properties.

Suitable fabric conditioning actives that can be used include quaternary ammonium compounds. Exemplary quaternary ammonium compounds include alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof.

Exemplary alkylated quaternary ammonium compounds include ammonium compounds having at least one alkyl group containing between 6 and 24 carbon atoms. Exemplary alkylated quaternary ammonium compounds include dialkyl dimethyl quaternary ammonium compounds, monoalkyl trimethyl quaternary ammonium compounds, and monomethyl trialkyl quaternary ammonium compounds. Suitable alkylated quaternary ammonium compounds may comprise a high level of dialkyl dimethyl quaternary ammonium compounds. Examples of the alkylated quaternary ammonium compounds are available commercially under the names Adogen™ Arosurf®, Variquat®, and Varisoft®. The alkyl group can be a C₈-C₂₂ group or a C₈-C₁₈ group or a C₁₂-C₂₂ group that may be aliphatic and saturated or unsaturated or straight or branched, a benzyl group, an alkyl ether propyl group, hydrogenated-tallow group, coco group, stearyl group, palmityl group, and soya group. A suitable alkyl group may be a straight chain, saturated C₁₂-C₂₂ group, or a C₁₄-C₂₂ group. Non-limiting examples of suitable straight chain, saturated alkyl groups include stearyl group, hydrogenated tallow alkyl group, and mixtures thereof. Exemplary ring or cyclic quaternary ammonium compounds include imidazolinium quaternary ammonium compounds and are available under the name Varisoft®. Exemplary imidazolinium quaternary ammonium compounds include methyl-1hydrogenated tallow amido ethyl-2-hydrogenated tallow imidazolinium-methyl sulfate, methyl-1-tallow amido ethyl-2-tallow imidazolinium-methyl sulfate, methyl-1-oleyl amido ethyl-2-oleyl imidazolinium-methyl sulfate, and 1-ethylene bis(2-tallow, 1-methyl, imidazolinium-methyl sulfate). Exemplary aromatic quaternary ammonium compounds include those compounds that have at least one benzene ring in the structure. Exemplary aromatic quaternary ammonium compounds include dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds. The alkyl group can contain between about 6 and about 24 carbon atoms, and can contain between about 10 and about 18 carbon atoms, and can be a stearyl group or a hydrogenated tallow group. Exemplary aromatic quaternary ammonium compounds are available under the names Variquat® and Varisoft®. The aromatic quaternary ammonium compounds can include multiple benzyl groups. Diquaternary ammonium compounds include those compounds that have at least two quaternary ammonium groups. An exemplary diquaternary ammonium compound may be N-tallow pentamethyl propane diammonium dichloride available under the name Adogen® 477. Exemplary alkoxylated quaternary ammonium compounds include methyldialkoxy alkyl quaternary ammonium compounds, trialkoxy alkyl quaternary ammonium compounds, trialkoxy methyl quaternary ammonium compounds, dimethyl alkoxy alkyl quaternary ammonium compounds, and trimethyl alkoxy quaternary ammonium compounds. The alkyl group can contain between about 6 and about 24 carbon atoms and the alkoxy groups can contain between about 1 and about 50 alkoxy groups units wherein each alkoxy unit contains between about 2 and about 3 carbon atoms. Exemplary alkoxylated quaternary ammonium compounds are available under the names Variquat®, Varstat®, and Variquat®. Exemplary amidoamine quaternary ammonium compounds include diamidoamine quaternary ammonium compounds. Exemplary diamidoamine quaternary ammonium compounds are available under the name Varisoft®. Non-limiting exemplary amidoamine quaternary ammonium compounds that can be used include methyl-bis(hydrogenated tallow amidoethyl)-2-hydroxyethyl ammonium methyl sulfate, methyl bis(tallowamidoethyl)-2-hydroxyethyl ammonium methyl sulfate, and methyl bis(stearoylamidoethyl)-2-hydroxyethyl ammonium methyl sulfate. Non-limiting exemplary ester quaternary compounds are methyl bis(stearoyloxyethyl)-2-hydroxyethyl ammonium methyl sulfate, dimethyl bis(stearoyloxyethyl) ammonium methyl sulfate, methyl bis (hydrogenated tallowoyloxyethyl)-2-hydroxyethyl ammonium methyl sulfate, and mixtures thereof. Other suitable quaternary ammonium compounds are disclosed, e.g., in USPA No. 2003/0195130 A1 and U.S. Pat. No. 6,107,270.

The quaternary ammonium compounds can include any counter ion that allows the component to be used in a manner that imparts fabric-softening properties. Exemplary counter ions include chloride, methyl sulfate, ethyl sulfate, and sulfate. However, chloride ion may be sometimes less preferred due to its tendency to cause rust of the steel dryer drums. Quaternary ammonium compounds that can be used as fabric softening actives can be available as relatively pure or concentrated quaternary ammonium compounds or they can be provided in a medium. Exemplary mediums include solvents and/or surfactants. When the quaternary ammonium compounds are provided in a medium, they can be provided in the medium in an amount of between at least about 50 wt. %, or between about 50 wt. % and about 99 wt. %, or between about 70 wt. % and about 95 wt. %, or between about 75 wt. % and about 90 wt. %. Exemplary mediums for the quaternary ammonium compounds include alcohols, glycols, nonionics, fatty alcohols, fatty acids, triglycerides, and solid esters. An exemplary alcohol that can be used is isopropanol. Exemplary glycols include hexylene glycol and propylene glycol. Exemplary nonionics include ethoxylated alcohols. Exemplary fatty alcohols include stearyl alcohols. Exemplary fatty acids include hard tallow acids and stearic acid. Exemplary triglycerides include hydrogenated tallow. Exemplary solid esters include stearyl stearate. In one aspect, the fabric softening active may comprise Varisoft DS-110™ which may comprise about 70% methyl bis (hydrogenated tallowamidoethyl)-2-hydroxyethyl ammonium methyl sulfate and about 30% of an ethoxylated fatty acid surfactant, and is available from Goldschmidt Chemical Company, Janeville, Wis.

### Carrier Component

The carrier component of the fabric conditioning composition can be any component suitable for containing the fabric softening active within the composition, allows the fabric softening active to transfer to wet laundry, and provides the fabric conditioning composition with a melting temperature or a softening temperature that may be greater than the operating temperature of the dryer. Exemplary carrier components include ethylene bisamides, primary alkylamides, alkanolamides, polyamides, alcohols containing at least 12 carbon atoms, alkoxylated alcohols containing alkyl chain of at least 12 carbon atoms, carboxylic acids containing at least 12 carbon atoms, and derivatives thereof.

Exemplary ethylene bisamides include those having the following formula 1:

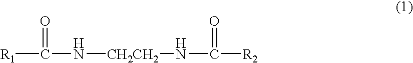

wherein R₁ and R₂ are alkyl groups containing at least 6 carbon atoms, and can be straight or branched, saturated or unsaturated, cyclic or noncyclic, and can include ethylene oxide groups and/or propylene oxide groups. R₁ and R₂ can be C₆-C₂₄ alkyl groups. R₁ and R₂ can be the same or different. Exemplary ethylene bisamides include ethylene bisteramide, ethylene bisoleamide, and ethylene bisbehenamide. A suitable ethylene bisamide may be Acrawax C™ which may comprise N,N′-ethylene bis-stearamide, and is available from IMS Company, Chagrin Falls, Ohio.

Exemplary primary alkylamides include those having the following formula 2:

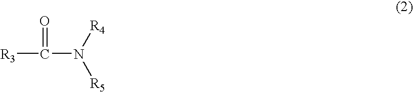

wherein R₃ may be a C₆-C₂₄ alkyl group that may be straight or branched, saturated or unsaturated, cyclic or noncyclic, and R₄ and R₅ can be hydrogen or C₁-C₂₄ alkyl groups that are straight or branched, saturated or unsaturated, cyclic or noncyclic. R₄ and R₅ can be the same or different. An exemplary primary alkylamide may be stearamide.

Exemplary alkanolamides include those having the following formula 3:

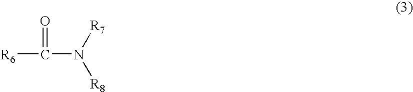

wherein R₆ may be a C₆-C₂₄ alkyl group that may be straight or branched, saturated or unsaturated, cyclic or noncyclic. R₇ and R₈ can be the same or different. When they are different, one can be hydrogen and the other can be an alkanol group such as C₂H₄OH or C₃H₆OH. When they are the same, they can each be an alkanol group such as C₂H₄OH or C₃H₆OH.

Exemplary alcohols include those having the following formula: R₉—OH, wherein R₉ may be a C₁₂ to C₂₄ alkyl group that can be straight or branched, saturated or unsaturated, cyclic or noncyclic. Exemplary alcohols include stearyl alcohol and behenyl alcohol. Exemplary alkoxylated alcohols include those having the formula: R₁₀—O(AO)ₓ, wherein R₁₀ may be a C₁₂-C₂₄ alkyl group that may be straight or branched, saturated or unsaturated, cyclic or noncyclic, and AO may be an ethylene oxide or propylene oxide group, and x may be a number from 1 to 100.

The fabric conditioning composition can be prepared by mixing the fabric softening active and the carrier component and any optional ingredients at a temperature sufficient to melt all the components. The step of mixing may take place at a temperature in excess of about 100° C. In general, the components should not be mixed at a temperature that is so high that it harms or discolors the components of the composition. For many components of the fabric conditioning composition, the mixing temperature can be less that about 180° C. An exemplary range for mixing may be from about 120° C. to about 150° C. In order to better preserve the perfume from a potential heat degradation, due to the relative high temperature of the molten fabric conditioning composition during manufacturing, the neat, non-encapsulated perfume composition, such as a low volatile perfume composition, may be added to the molten fabric conditioning composition as late as possible before the resulting molten fabric conditioning mixture is extruded or molded. Furthermore, in order to reduce possible degradation from the effect of high heat and oxidation, the molten components and molten composition may be processed, e.g., heated, mixed, and/or molded, under a headspace or a blanket of nitrogen.

Once the components are sufficiently mixed, the composition may be shaped to the desired form. The form can be provided as a solid unitary structure. Exemplary forms include blocks or strips that can be placed within a drying machine so that a surface of the fabric conditioning composition is exposed to laundry during the drying operation. Exemplary forms include a rectangular block and a rectangular strip. Additional forms include half-cylindrical shapes with the exposed surfaces and edges being curved or rounded for better dispensing. The fabric conditioning composition may be provided having a size of at least about 5 grams. An exemplary size may be about 30 g to about 170 g. The fabric softening active and the carrier component can be mixed together to provide a fabric conditioning composition that releases a desired amount of fabric softening active during the drying cycle when placed inside of a dryer.

An exemplary weight ratio of fabric softening active to carrier component may be from about 1:19 to about 19:1. The ratio of the fabric softening active to the carrier component can be from about 1:10 and about 10:1, and can be from about 3:7 and about 9:1. It should be understood that the reference to the fabric softening active refers to the material responsible for providing fabric-softening properties, and is not meant to include the medium that may be present with the fabric softening active. That is, the fabric softening active may be commercially available in a medium that can be a solvent or a surfactant. Furthermore, the medium can be the same as or different from the carrier component.

### Perfume Component

The optional perfume component may comprise a component selected from the group consisting of
(1) a perfume microcapsule, or a moisture-activated perfume microcapsule, comprising a perfume carrier and an encapsulated perfume composition, wherein said perfume carrier may be selected from the group consisting of cyclodextrins, starch microcapsules, porous carrier microcapsules, and mixtures thereof; and wherein said encapsulated perfume composition comprises low volatile perfume ingredients, high volatile perfume ingredients, and mixtures thereof;
(2) a pro-perfume;
(3) a low odor detection threshold perfume ingredients, wherein said low odor detection threshold perfume ingredients may comprise less than about 25%, by weight of the total neat perfume composition; and
(4) mixtures thereof; and

The weight ratio of the fabric softening active to said carrier component may be from about 1:19 to about 19:1. In one aspect, the fabric conditioning composition exhibits a melting point greater than about 90° C.

### Perfume Microcapsules

In one aspect, the multiple use fabric conditioning composition may comprise a perfume microcapsule comprising a perfume carrier and an encapsulated perfume composition, to provide a long lasting perfume benefit on fabric and/or to reduce the perfume odor intensity of the multiple use fabric conditioning composition.

In one aspect, the multi-use fabric conditioning composition may comprise a perfume microcapsule. In one aspect, the perfume microcapsule may be moisture-activated. Non-limiting examples of moisture-activated perfume carriers include, e.g., cyclodextrins, starch capsules, porous carriers such as zeolites, and mixtures thereof. Thus, the perfume can be encapsulated in the form of, e.g., the following: molecular encapsulation, such as inclusion in a complex with a cyclodextrin, coacervate microencapsulation wherein a perfume droplet may be enclosed in a solid wall material, “cellular matrix” encapsulation wherein perfume micro droplets are stably held in cells of solid micro particles, or perfume embedded in, e.g., starch or sugar matrix, and mixtures thereof, wherein the encapsulated perfume composition may contain substantive perfume ingredients, and wherein the neat, free perfume can be any suitable perfume. There are however, perfume characteristics which are preferred for use on fabrics to provide, e.g., a fresh fabric impression. Non-limiting perfume ingredients for use in the neat perfume and/or encapsulated perfume herein are given in U.S. Pat. No. 5,714,137.

Cyclodextrin. A suitable moisture-activated perfume carrier that may be useful in the disclosed multiple use fabric conditioning composition may comprise cyclodextrin. As used herein, the term “cyclodextrin” includes any of the known cyclodextrins such as unsubstituted cyclodextrins containing from six to twelve glucose units, especially beta-cyclodextrin, gamma-cyclodextrin, alpha-cyclodextrin, and/or derivatives thereof, and/or mixtures thereof. A more detailed description of suitable cyclodextrins is provided in U.S. Pat. No. 5,714,137. Suitable cylodextrins herein include beta-cyclodextrin, gamma-cyclodextrin, alpha-cyclodextrin, substituted beta-cyclodextrins, and mixtures thereof. In one aspect, the cyclodextrin may comprise beta-cyclodextrin. Perfume molecules are encapsulated into the cavity of the cyclodextrin molecules to form molecular microcapsules, commonly referred to as cyclodextrin/perfume complexes. The perfume loading in a cyclodextrin/perfume complex may comprise from about 3% to about 20%, or from about 5% to about 18%, or from about 7% to about 16%, by weight of the cyclodextrin/perfume complex.

The cyclodextrin/perfume complexes hold the encapsulated perfume molecules tightly, so that they can prevent perfume diffusion and/or perfume loss, and thus reducing the odor intensity of the multiple use fabric conditioning composition. However, the cyclodextrin/perfume complex can readily release some perfume molecules in the presence of moisture, thus providing a long lasting perfume benefit. Non-limiting examples of preparation methods are given in U.S. Pat. Nos. 5,552,378, and 5,348,667.

Suitable cyclodextrin/perfume complexes (or perfume cyclodextrin microcapsule) may have a small particle size, typically from about 0.01 to about 200 micrometer, or from about 0.1 less than about 150 micrometer, or from about 1.0 to about 100 micrometer, or from about 10 to about 50 micrometer.

The multiple use fabric conditioning compositions may comprise of from about 0.1% to about 25%, or from about 1% to about 20%, or from about 3% to about 15%, or from about 5% to about 10%, by weight of the total fabric conditioning composition, of cyclodextrin/perfume complex.

Moisture-Activated Cellular Matrix Microcapsule Moisture-activated and/or water-soluble perfume cellular matrix microcapsules are solid particles containing perfume stably held in the cells within the particles. Details about moisture-activated perfume cellular matrix microcapsules are disclosed in PCT Publication WO 01/85888 and U.S. Pat. No. 3,971,852. A suitable moisture-activated perfume cellular matrix microcapsule may be perfume starch microcapsule which uses starch as the cellular matrix material.

Moisture-activated perfume cellular matrix microcapsules may have a size of from about 0.5 micron to about 300 microns, from about 1 micron to about 200 microns, or from about 2 microns to about 100 microns. The perfume loading in the cellular matrix microcapsules may range from about 20% to about 70%, or from about 40% to about 60%, by weight of the microcapsules. Sufficient amount of perfume moisture-activated microcapsules should be used to deliver the desired levels of perfume, depending on the perfume loading of the microcapsules. For microcapsules with a perfume loading of about 50%, typical level of the matrix microcapsules may comprise from about 0.1% to about 15%, from about 0.5% to about 7%, from about 0.8% to about 8%, or from about 1% to about 6%, by weight of the multiple use fabric conditioning composition.

A dispersing agent may be used to distribute the moisture-activated perfume cellular matrix microcapsules uniformly in the molten multiple use fabric conditioning composition. Suitable dispersing agents for use in combination with moisture-activated cellular microcapsules include block copolymer having blocks of terephthalate and polyethylene oxide. More specifically, these polymers are comprised of repeating units of ethylene and/or propylene terephthalate and polyethylene oxide terephthalate at a molar ratio of poly(ethylene/propylene) terephthalate units to polyethylene oxide terephthalate units of from about 25:75 to about 35:65, said polyethylene oxide terephthalate containing polyethylene oxide blocks having molecular weights of from about 300 to about 2,000 Daltons. The molecular weight of this polymeric dispersing agent may be in the range of from about 5,000 to about 55,000 Daltons.

Another suitable dispersing agent for use in combination with moisture-activated cellular microcapsules may be block copolymer having blocks of polyethylene oxide and of polypropylene oxide. Non-limiting examples of dispersing agent of this type include Pluronic® surfactants and Tetronic® surfactants. Pluronic® surfactants have the general formula H(EO)ₙ(PO)ₘ(EO)ₙH, wherein EO is an ethylene oxide group, PO is a propylene oxide group, and n and m are numbers that indicate the average number of the groups in the surfactants. Non-limiting examples of suitable Pluronic® surfactants include:

| Name | Average MW | Average n | Average m |
|---|---|---|---|
| L-101 | 3,800 | 4 | 59 |
| L-81 | 2,750 | 3 | 42 |
| L-44 | 2,200 | 10 | 23 |
| L-43 | 1,850 | 6 | 22 |
| F-38 | 4,700 | 43 | 16 |
| P-84 | 4,200 | 19 | 43, |

and mixtures thereof.

Tetronic® surfactants have the general formula:

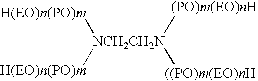

wherein EO, PO, n, and m have the same meanings as above. Non-limiting typical examples of suitable Tetronic® surfactants are:

| Name | Average MW | Average n | Average m |
|---|---|---|---|
| 901 | 4,700 | 3 | 18 |
| 908 | 25,000 | 114 | 22, |

and mixtures thereof.

In the process of preparing a multiple use fabric conditioning bar, a suitable dispersing agent may first be added to the fabric conditioning composition melt mixture with mixing, and the moisture-activated perfume starch microcapsules may then be added to the melt mixture with mixing, and the resulting mixture may be poured into a mold to form a multiple use fabric conditioning bar.

Porous Carrier Microcapsule. A portion of the perfume composition can also be absorbed onto and/or into a porous carrier, such as zeolites or clays, to form perfume porous carrier microcapsules in order to reduce the amount of free perfume in the multiple use fabric conditioning composition. When the perfume is to be adsorbed onto zeolite, the perfume ingredients forming the encapsulated perfume composition can be selected according to the description provided in U.S. Pat. No. 5,955,419. Suitable perfume ingredients for use with porous mineral carrier materials, such as clays and zeolites or clays, particularly dehydrated/activated zeolites, include those that do not comprise a high level of unstable perfume ingredients that degrade upon incorporation into said porous mineral carrier material. Non-limiting examples of such perfume ingredients are given in USPA No. 2003/0013632 A1.

Pro-perfume. The perfume composition may additionally include a pro-perfume. Pro-perfumes may comprise nonvolatile materials that release or convert to a perfume material as a result of, e.g., simple hydrolysis, or may be pH-change-triggered pro-perfumes (e.g. triggered by a pH drop) or may be enzymatically releasable pro-perfumes, or light-triggered pro-perfumes. The pro-perfumes may exhibit varying release rates depending upon the pro-perfume chosen. Pro-perfumes suitable for use in the disclosed compositions are described in the following: U.S. Pat. Nos. 5,378,468; 5,626,852; 5,710,122; 5,716,918; 5,721,202; 5,744,435; 5,756,827; 5,830,835; 5,919,752 and in WO 00/02986 and 01/04248.

Optional Ingredients. The composition may contain effective amounts of optional ingredients, such as, soil release agent, chelant, dye transfer inhibitor, dye fixative agent, chlorine scavenging agent, optical brightener, odor control agent, antimicrobial agent, fungicide, wrinkle control agent, anti-oxidant, preservative, plasticizer, insect repellent, moth repellent, processing aid, mold release agent, and mixtures thereof. Suitable soil release polymers, chelants, dye transfer inhibitors, dye fixatives, chlorine scavengers, and anti-oxidants are given in U.S. Pat. No. 6,046,154 and references cited therein. Suitable odor control agents (such as cyclodextrins, metal salts, and zeolites), wrinkle control agents, antimicrobial agents, fungicides, preservatives, insect repellents, and moth repellents are given in U.S. Pat. No. 5,968,404 and references cited therein.

Processing Agent. A non-limiting example of a processing agent may be hydrocarbon polymers, such as Vybar™103 polymer, available from Baker Petrolite Polymers Division of Baker Hughes, Sand Springs, Okla. This hydrocarbon polymer helps to eliminate bubbles, mottling and acts as a perfume binder.

The fabric conditioning composition can be operably connected the inside surface of a tumble dryer, e.g., on a dryer fin (or baffle) of a dryer so that the composition contacts the wet laundry during the drying operation. The composition can be attached to the inside of the dryer, e.g., by a cradle such as the cradle disclosed by published USPA No. 2003/0192197.

During the drying cycle, the fabric conditioning composition should release a sufficient amount of the fabric conditioning composition to provide a desired level of softening and freshening properties and, if desired, antistatic properties. In addition, the fabric conditioning composition should not release too much of the fabric softening active that would result in spotting of the laundry. It is expected that during the drying cycle, the fabric conditioning composition will release between about 0.01 to about 1 gram of the fabric conditioning composition per pound of dry laundry. The amount released per drying cycle can be from about 0.02 to 0.75 gram of the fabric conditioning composition per pound of dry laundry, and can be from about 0.05 to about 0.50 gram of fabric conditioning composition per pound of dry laundry. It should be understood that the size of the dryer and the size of the fabric conditioning composition can vary for different types of dryers and drying conditions. For example, there are various sizes of dryers that are commonly used in industrial laundry facilities and in residential or consumer environments.

The dryers in which the disclosed multiple use fabric conditioning compositions may be used include any type of automatic clothes dryer that uses heat and agitation to remove water from the laundry. An exemplary dryer includes a tumble-type dryer that is heated by electricity or gas, wherein the laundry is provided within a rotating drum that causes the laundry to tumble during the operation of the dryer.

Examples of suitable fabric conditioning compositions include those described at paragraphs [0029] to [0051] of published USPA No. 2003/0195130 A1, wherein the perfume used is Perfume A given hereinabove.

The following are more non-limiting examples of the instant composition.

TABLE 1
Examples 1-3

| | Example 1 | Example 2 | Example 3 |
|---|---|---|---|
| Ingredients | Wt. % | Wt. % | Wt. % |
| Acrawax ® C^{(a)} | 51 | 47.6 | 47 |
| Varosoft ® DS-110^{(b)} | 45.5 | 45.7 | 45.3 |
| Vybar ™ 103 | 2 | — | — |
| Aminosilicone^{(c)} | 2.5 | — | 1 |
| Cyclodextrin/Perfume | — | 6.7 | 6.7 |
| Complex^{(d)} | | | |
| Total | 100 | 100 | 100 |

TABLE II
Examples 4-6

| | Example 4 | Example 5 | Example 6 |
|---|---|---|---|
| Ingredients | Wt. % | Wt. % | Wt. % |
| Acrawax ® C | 48 | 50 | 40 |
| Varosoft ® DS-110 | 45 | 44 | 53 |
| Vybar ™ 103 | 2 | — | — |
| Aminosilicone^{(c)} | — | 1 | 2 |
| Perfume starch microcapsules | 3 | 3 | — |
| Polyethylene/polypropylene | 2 | 2 | — |
| terephthalate-polyethylene | | | |
| oxide block copolymer | | | |
| Cyclodextrin^{(e)} | — | — | 5 |
| Total | 100 | 100 | 100 |

^{(a)}Ethylene bis-stearamide
^{(b)}Comprising about 70% methyl bis-(hydrogenated tallow amidoethyl) 2-hydroxyethyl ammonium methyl sulfate and about 30% alkyl ethoxylate, available from Goldschmidt Chemical Corporation, Janesville, Wisconsin.
^{(c)}KF-8732, X22-3908A-Base, X22-8699-2, X22-8699, X22-8699-3, or X22-8699-5, all available from available from Shin-Etsu silicones, Akron OH.
^{(d)}Perfume complex of beta-cyclodextrin.
^{(e)}Uncomplexed beta-cyclodextrin, with particle size of less than about 20 micrometers.

In Examples 4 and 5, the poly(ethylene/propylene) terephthalate-polyethylene oxide terephthalate block copolymer may be added to the softener melt mixture with mixing, before the starch microcapsules are added to the mixture with mixing, and the resulting mixture may be poured into a mold to form a multiple use fabric conditioning bar.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-use fabric conditioning composition comprising:
(a) from about 0.1% to about 10% based on total multi-use fabric conditioning composition, of an aminosilicone having the structure of Formula I
[R₁R₂R₃SiO_{1/2}]ₙ[(R₄Si(X—Z)O_{2/2}]ₖ[R₄R₄SiO_{2/2}]ₘ[R₄SiO_{3/2}]ⱼ (Formula I)
wherein
i) R₁, R₂, R₃ and R₄ are each independently selected from H, C₁-C₂₀ alkyl, C₁-C₂₀ substituted alkyl, C₆-C₂₀ aryl, C₆-C₂₀ substituted aryl, alkylaryl, C₁-C₂₀ alkoxy and combinations thereof;
ii) X is a divalent alkylene radical comprising 2-12 carbon atoms, or is independently selected from the group consisting of —(CH₂)s—; —CH₂—CH(OH)—CH₂—; 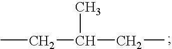
and mixtures thereof; wherein s is on average from about 2 to about 10;
iii) Z is selected from the group consisting of 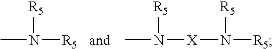
wherein R₅ is selected from H, C₁-C₂₀ alkyl, C₁-C₂₀ substituted alkyl, and combinations thereof;
iv) k is on average from about 3 to about 20;
v) m is on average from about 100 to about 2,000;
vi) n is on average from about 2 to about 10;
vii) j is on average from about 0 to about 10; and
(b) a fabric softening active;
(c) a carrier component;
(d) an optional perfume component selected from the group consisting of
(1) a perfume microcapsule, comprising a perfume carrier and an encapsulated perfume composition, wherein said perfume carrier is selected from the group consisting of cyclodextrins, starch microcapsules, porous carrier microcapsule, and combinations thereof; and wherein said encapsulated perfume composition comprises low volatile perfume ingredients, high volatile perfume ingredients, and mixtures thereof;
(2) a pro-perfume;
(3) a low odor detection threshold perfume ingredients, wherein said low odor detection threshold perfume ingredients comprise less than about 25%, by weight of the total neat perfume composition; and
(4) mixtures thereof; and
(e) an optional ingredient selected from the group consisting of soil release agent, chelant, dye transfer inhibitor, dye fixative agent, chlorine scavenging agent, optical brightener, odor control agent, antimicrobial agent, fungicide, wrinkle control agent, anti-oxidant, preservative, insect repellent, moth repellent, processing agent, mold release agent, and mixtures thereof;
wherein the weight ratio of said fabric softening active to said carrier component is from about 1:19 to about 19:1, and wherein said fabric conditioning composition exhibits a melting point greater than about 90° C.

2. A fabric conditioning composition according to claim 1 wherein
i) R₁ is each independently selected from H, OH, methyl, C₁-C₂₀ alkoxy, and combinations thereof;
ii) R₂, R₃ and R₄ are methyl groups;
iii) Z is selected from 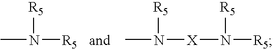
wherein R₅ is selected from the group consisting of H, C₁-C₂₀ alkyl, and combinations thereof;
iv) X is independently selected from the group consisting of —(CH₂)s—; —CH₂—CH(OH)—CH₂—; 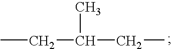
and mixtures thereof, wherein s is on average from about 2 to about 6;
v) k is on average from about 3 to about 20;
vi) m is on average from about 150 to about 1,000;
vii) n is on average from about 2 to about 6; such that n is equal to j+2; and
viii) j is from about 0 to about 4.

3. The fabric conditioning composition of claim 1, wherein said fabric conditioning composition exhibits a melting point greater than 90° C.

4. The fabric conditioning composition of claim 1 wherein said composition is a result of melt mixing said fabric softening active, said carrier component, and said aminosilicone.

5. The fabric conditioning composition of claim 1 wherein the weight ratio of said fabric softening active to said carrier component is from about 1:19 to about 19:1.

6. The fabric conditioning composition of claim 1, wherein said composition further comprising a perfume component, wherein said perfume component comprises at least one of:
(a) a perfume microcapsule comprising a perfume carrier and an encapsulated perfume composition;
(b) a pro-perfume;
(c) a low odor detection threshold perfume ingredients; or
(d) a mixtures thereof.

7. The fabric conditioning composition of claim 6 wherein said perfume component comprises a perfume microcapsule, and wherein said microcapsule comprises a moisture-activated microcapsule.

8. The fabric conditioning composition of claim 7, wherein said moisture-activated microcapsule comprises a cyclodextrin perfume carrier.

9. The fabric conditioning composition of claim 1 wherein said fabric conditioning composition comprises of from about 0.1% to about 25%, by weight of the total fabric conditioning composition, of said cyclodextrin perfume microcapsule.

10. The fabric conditioning composition of claim 7 wherein said moisture-activated microcapsule is beta-cyclodextrin.

11. The fabric conditioning composition of claim 7 wherein said moisture-activated microcapsule comprises a cellular matrix microcapsule.

12. The fabric conditioning composition of claim 11 wherein said cellular matrix microcapsule comprises a perfume starch microcapsule, and wherein said multiple use fabric conditioning composition comprises of from about 0.1% to about 15%, by weight of the total fabric conditioning composition, of the perfume starch microcapsule.

13. The fabric conditioning composition of claim 1 comprising a dispersing agent for the perfume starch capsule.

14. The fabric conditioning composition of claim 13 wherein said dispersing agent is chosen from at least one of poly(ethylene/propylene) terephthalate-polyethylene oxide terephthalate block copolymers, polypropylene terephthalate-polyethylene oxide terephthalate block copolymers, ethylene oxide and propylene oxide block copolymers, or mixture thereof.

15. The fabric conditioning composition of claim 7, wherein said moisture-activated microcapsule comprises a porous perfume carrier microcapsule.

16. The fabric conditioning composition of claim 1 wherein said fabric conditioning composition comprises from about 0.1% to about 25%, by weight of the fabric conditioning composition, of said porous perfume carrier microcapsule.

17. The fabric conditioning composition of claim 1 wherein said perfume component comprises a pro-perfume, wherein said pro-perfume chosen from an acetal pro-perfume, ketal pro-perfume, ester pro-perfume, hydrolyzable inorganic-organic pro-perfumes, and a mixture thereof.

18. The fabric conditioning composition of claim 1, wherein the fabric softening active comprises at least one of methyl bis(tallowamidoethyl)-2-hydroxyethyl ammonium methyl sulfate, and methyl bis(hydrogenated tallowamidoethyl)-2-hydroxyethyl ammonium methyl sulfate, methyl bis(stearyloyloxyethyl)-2-hydroxyethyl ammonium methyl sulfate, dimethyl bis (stearyloyloxyethyl) ammonium methyl sulfate, methyl bis(hydrogenated tallowoyloxyethyl)-2-hydroxyethyl ammonium methyl sulfate, or a mixture thereof.

19. A method of softening a fabric comprising the step of contacting said fabric with a composition according to claim 1.
